(19) United States
(12) Patent Application Publication
(10) Pub. No.: US 2015/0159730 A1
(43) Pub. Date: Jun. 11, 2015

(54) DAMPING DEVICE HAVING A ROTARY DAMPER

(71) Applicant: AUDI AG, INGOLSTADT (DE)

(72) Inventor: Marco Willems, Ingolstadt (DE)

(73) Assignee: AUDI AG, INGOLSTADT (DE)

(21) Appl. No.: 14/399,818

(22) PCT Filed: Apr. 23, 2013
(86) PCT No.: PCT/EP2013/001207

§ 371 Date: Nov. 7, 2014

(30) Foreign Application Priority Data
May 8, 2012 (DE) 10 2012 009 168.0

(51) Int. Cl. F16F 15/03; B60G 13/14; F16H 35/10

(52) U.S. Cl. CPC F16F 15/035; F16H 35/10; B60G 13/14

(57) ABSTRACT

A damping device having a rotary damper for a vehicle for damping a pivoting motion occurring at an input element, in particular a coupling rod, wherein during pivoting the input element operates on the rotary damper via a gear mechanism. The input element is coupled to the gear mechanism by way of a slip coupling such that the torques occurring at the slip coupling that are above a predetermined threshold torque result in a relative movement between the input element and the gear mechanism.

The invention relates to a damping device having a rotary damper according to the preamble of claim 1.

Electrical or hydraulic dampers may be provided as rotary dampers in mechanical damping devices. The dampers remove energy from an oscillatory system to dampen vibrations. Advantageously, electrical rotary dampers can be used, as these are capable of generating from the vibration energy electric energy, which can then be supplied, for example, to the onboard electrical system of a motor vehicle in which the damping device with the electric rotary damper is arranged.

DE 10 2010 035 084 A1 discloses an electric damper for a motor vehicle which can be used to dampen a relative motion between two components. A coupling rod deflectable about an axis is coupled via a planetary gear with the rotor of the generator acting as a rotary damper. The rotor is rotated via the planetary gear by an excursion of the coupling rod. Due to the electrical induction, a reaction force operates against the direction of rotation of the rotor which causes damping of the excursion movement of the coupling rod.

The coupling rod of such a damping device is displaced about its axis in a relatively small angular range by the vibration movements to be damped. As a result, a gear rigidly connected with the coupling rod, for example a ring gear of a planetary gear, is then also always deflected only in a small angular range, whereby the gear(s) of the first gear stage are unevenly loaded. This can lead to in an uneven and locally excessive wear of the gears especially at high impact loads operating on the coupling rod, which may adversely affect the service life of the gear disposed between the coupling rod and the rotary damper.

It is the object of the invention to provide a damping device with a rotary damper coupled to an input element via a gear, which is less susceptible to wear under higher impulse loads.

The object is attained with the features of claim 1. Preferred embodiments of the invention are disclosed in the dependent claims.

The invention is based on a rotary damper having an input element on which is a pivoting movement about a pivot axis is imparted, for example when driving. In accordance with the characterizing part of claim 1, the input element of the damping device is coupled with a gear mechanism via a slip coupling, so that torques above a predetermined limit torque occurring at the sliding clutch cause a relative movement between the input element and the gear mechanism. As a result, any impact loads applied at the input element are passed to the gear mechanism only up to a limit torque, thus preventing overloading of the gear teeth. The slippage of the input element occurring under such an impact load alters its position relative to gear of the gear mechanism coupled via the slip coupling. The gear coupled with the input element via the slip coupling is hence not always loaded in the same partial angular range.

In one embodiment, the input element of the rotary damper may be constructed as a coupling rod, which is part of a wheel suspension. In the wheel suspension, a control arm from a control arm assembly articulated on a wheel carrier may be pivotally connected to the vehicle body via the coupling rod and via a pivot axis.

Other aspects of the invention will be explained with reference to a design where the input element is specifically constructed as a coupling rod. It will be understood, however, that the invention is not limited to such a coupling rod, but may encompass any type of input element.

The rotary damper is preferably designed as an electric rotary damper operating as a generator. The generator converts the energy required for damping an excursion movement occurring at the coupling rod into electric energy, which may then be supplied, for example, to the onboard electrical system of a motor vehicle.

In a particularly advantageous embodiment, the damping device may be constructed such that the limit torque of the slip coupling is adjustable. In this way, the limit torque can be adapted to different driving situations or even to different applications.

The slip coupling is preferably interposed between the coupling rod and of a first stage of a multistage gear mechanism. For example, this may involve a two-stage planetary gear, whose ring gear of the first gear stage is coupled to the coupling rod via the slip coupling. The slip coupling may advantageously be arranged between the cylindrical peripheral surface of the ring gear and a mounting eye of the coupling rod. The coupling rod may also be coupled with the first stage of gear mechanism in other ways, for example via a flange and a disk-shaped slip coupling. The design of the slip coupling used in each case can be adapted to the particular application, with a slip coupling encompassing a ring gear enabling a very compact and hence space-saving overall design for the damping device.

Such a space-saving arrangement is also obtained when the slip coupling disposed between the gear housing and the coupling rod is constructed in the form of a slip coupling that circularly surrounds the gear housing.

Depending on the application, the coupling rod may advantageously be constructed with a mounting eye or a connecting flange, so that the slip coupling which is effective between the gear mechanism and coupling rod can be attached in this region.

The invention will now be explained in more detail with reference to exemplary embodiments illustrated in the drawing.

The drawing shows in:

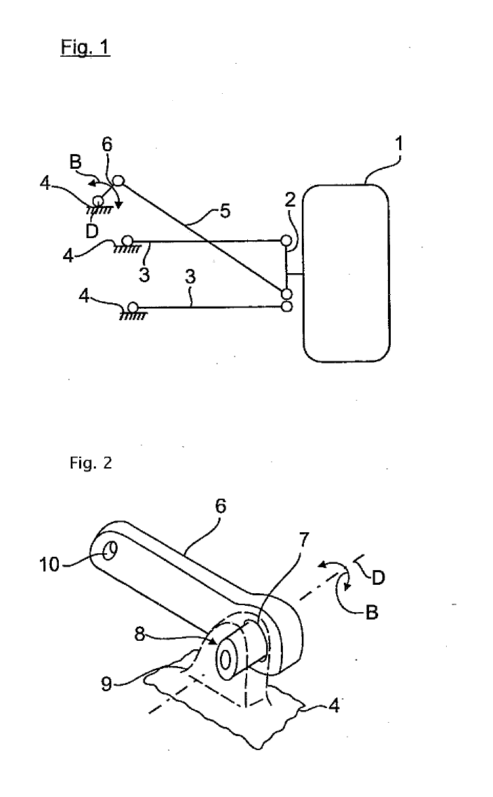

FIG. 1 a schematic diagram of a wheel suspension of a vehicle wheel,

FIG. 2 a damping device with a coupling rod and a rotary damper,

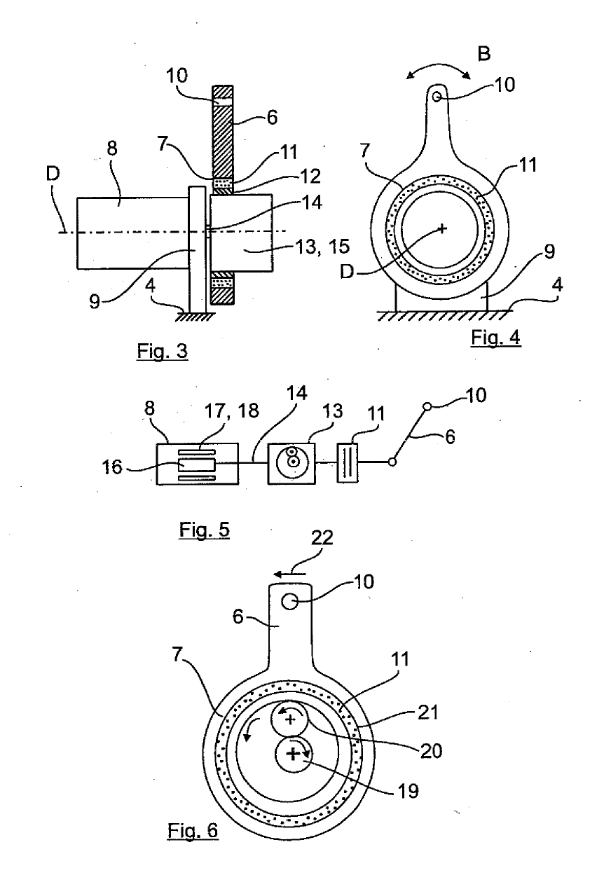

FIG. 3 a side view of a damping device having an ring-shaped slip coupling,

FIG. 4 an end view of the damping device of FIG. 3,

FIG. 5 a schematic diagram of the damping device of FIG. 3 in the form of functional blocks, and

FIG. 6 a simplified cross section of a damping device in the region of the first gear stage of a planetary gear mechanism.

FIG. 1 shows the wheel suspension of a vehicle wheel 1 of a motor vehicle. The vehicle wheel 1 is rotatably mounted on a wheel carrier 2. The wheel carrier 2 is articulated on the vehicle body 4 by way of transverse control arms 3. In addition, a trailing arm 5 operates on the wheel carrier 2, which is pivotally connected to the vehicle body 4 via a coupling rod 6 and via a pivot axis D.

FIG. 2 shows the point of articulation between the coupling rod 6 and the vehicle body 4. The coupling rod 6 is coupled in the region of a mounting eye 7 with an electric damper 8 (not shown in detail). The electric damper 8 is inserted in a holder 9, which is indicated here by way of example with broken lines.

The coupling rod 6 can be deflected by vibrations occurring at the wheel carrier 2 about the pivot axis D in accordance with the double arrow B (FIG. 1). The vibrations are transferred to the connecting rod 6 via the trailing arm 5 of FIG. 1, which is coupled with the coupling rod 6 at the bore 10. The electric rotary damper 8 operating as a generator causes damping of these vibrations.

FIG. 3 shows the side view of a damping device with a rotary damper 8, which cooperates with the coupling rod 6 via a gear mechanism 13 and a slip coupling 11. The coupling rod 6 together with the inserted slip coupling 11 is shown in cross-section. The slip coupling 11 encompasses a bearing ring 12 which is connected to the housing 15 of the gear mechanism 13 in fixed rotational engagement. On the other hand, the slip coupling 11 is inserted in a mounting eye 7 of the coupling rod 6.

The rotary damper 8 is disposed in the holder 9 in fixed rotational engagement, while the gear mechanism 13 is pivotable about the pivot axis D by way of the housing 15. An excursion of the coupling rod 6 and an associated pivoting movement of the gear mechanism 13 about the pivot axis D initiate a rotation of the gear shaft 14 leading to the rotary damper 8. This rotation is damped in a rotary damper 8 in a conventional manner.

The end view of FIG. 4 shows the axially-symmetric construction of the gear mechanism 13 and the slip coupling 11, which are inserted together in the mounting eye 7 of the coupling rod 6. Any excursion movements occurring on the coupling rod 6, corresponding to the double arrow B, are directly transmitted to the gear mechanism 13, as long as a predetermined torque limit is not exceeded. Since the excursion movements about the pivot axis D are attenuated by the rotary damper 8, a torque occurs at the slip coupling 11. When this torque exceeds a predetermined value, the coupling rod 6 slips on the slip coupling 11, i.e. a relative movement occurs between the coupling rod 6 and the gear mechanism 13, causing the resting position of the coupling rod 6 to move in relation to the gear mechanism 13.

In FIG. 5, functional blocks show the different elements of the damping device. The coupling rod 6 is coupled with the gear mechanism 13 via the slip coupling 11, which is indicated here as a planetary gear. The output stage of the gear mechanism 13 drives the rotor 16 of an electric rotary damper 8 via the gear shaft 14, wherein the stator 17 of the electric rotary damper 8 has induction coils 18. A pivotal movement on the coupling rod 6 is transmitted up to a limit torque directly to the gear mechanism 13, thereby causing the rotor 16 to rotate. The rotation of the rotor 16 generates through induction a force opposing the rotation.

FIG. 6 shows the first gear stage of the gear mechanism 13, which is here constructed as a planetary gear mechanism. The sun gear 19 which is arranged coaxially in relation to the rotary damper 8 (not visible here) is coupled with an internally-toothed ring gear 21 via a planet gear 20. The meshing gears 19 to 21 are shown here in simplified form.

An excursion of the coupling rod 6 in accordance with the direction of the arrow 22 causes rotational movements of the gears 19 to 21 in accordance with the directions of the corresponding indicated arrows. A damping force counteracting the excursion movement of the coupling rod 6 is then transferred to the ring gear 21 via the sun gear 19 and the planet gear 20. This damping force is the greater, the greater the damping effect of the rotary damper 8 is. During fast or impulse-like excursion movements of the coupling rod 6, the damping produced by the rotary damper 8 can be so strong that the torque occurring at the slip coupling 11 exceeds a torque limit, causing the coupling rod 6 to slip and perform a relative movement relative to the ring gear 21. In this case, the slip coupling 11 causes the coupling rod 6 to slip with respect to the ring gear 21. This changes the relative position between the coupling rod 6 and the ring gear 21, causing other gear rim regions of the gears 19 to 21 to engage with each other. All gear rim regions of the gears 19 to 21 are then uniformly utilized and loaded if the limit torque is frequently exceeded over a longer period of time.

1-7. (canceled)

8. A damping device for a vehicle, the damping device comprising:
a rotary damper for damping a pivoting movement occurring at an input element, said rotary damper comprising
a rotor,
a gear mechanism coupled to the rotor and driven by the input element during the pivoting movement,
a slip coupling that couples the input element with the gear mechanism,
wherein torques occurring at the slip coupling that are above a predetermined limit torque cause a relative movement between the input element and the gear mechanism.

9. The damping device of claim 8, wherein the input element is a coupling rod.

10. The damping device of claim 8, wherein the rotary damper is an electric rotary damper operating as a generator.

11. The damping device of claim 8, wherein the limit torque is adjustable.

12. The damping device of claim 8, wherein the gear mechanism is a multi-stage gear mechanism and the slip coupling is arranged between the input element and a first stage of the multi-stage gear mechanism.

13. The damping device of claim 8, wherein the gear mechanism is a planetary gear and the slip coupling is arranged between the input element and a ring gear of the planetary gear.

14. The damping device of claim 8, wherein the slip coupling is arranged between the input element and a housing of the gear mechanism.

15. The damping device of claim 8, wherein the input element comprises a mounting eye or a connecting flange, with which the input element engages on the slip coupling.
